(19) United States
(12) Patent Application Publication
(10) Pub. No.: US 2009/0184116 A1
(43) Pub. Date: Jul. 23, 2009

(54) PORTABLE, NESTABLE STORAGE AND CARRYING MEANS FOR FOOD AND DRINK HAVING INTEGRATED RELEASABLE SERVING MEANS

(76) Inventor: Lawrence L. Laske, Libertyville, IL (US)

Correspondence Address: Intellectual Property Dept.;Dewitt Ross & Stevens SC, 2 East Mifflin Street, Suite 600, Madison, WI, 53703-2865, US

(21) Appl. No.: 12/356,404

(22) Filed: Jan. 20, 2009

Related U.S. Application Data
(60) Provisional application No. 61/062,016, filed on Jan. 23, 2008.

(51) Int. Cl. B65D 8/00; B65D 25/28

(52) U.S. Cl. 220/4.28; 220/752

(57) ABSTRACT

Described is a container for transporting and storing food and drink for pets having an integrated releasable serving means. In one version of the invention, a portable container body having an integrated, releasable base provides a means for serving food or drink to an animal when away from home. In such an embodiment, the base is removed from the container body and the contents of the container are poured into the base and the base set on the ground or other stable surface for consumption of the product by a pet. In an alternate version, a container body has a releasable lid formed such that the contents of the container can be poured into the lid and the lid set on the ground or other stable surface for consumption of the product by a pet.

### CROSS-REFERENCE TO RELATED APPLICATIONS

Priority is hereby claimed to provisional application Ser. No. 61/062,016, filed Jan. 23, 2008, which is incorporated herein by reference.

### FIELD OF THE INVENTION

The present invention generally relates to a portable food and drink storage and carrying device for pets and, more particularly, to a storage and carrying device for transporting food and drink for pets having an integrated releasable serving means.

### BACKGROUND OF THE INVENTION

Many people have pets such as dogs and cats for companionship. The provision of food and drink and care for dogs and other pet animals is today often approached with virtually the same diligence as applied to human family members. Because of the strong emotional bond between dogs and their owners, dogs are frequently taken on both recreational and exercise excursions. In addition to the companionship they provide, dogs are also taken on these excursions for protection. While on these excursions, food and drink for dogs is very important. There are many dry dog foods and treats for pets which lend themselves to being transported, yet it is not desirable to have pets eat out of your hand or eat of the ground. In addition, providing drinks for pets when away from home is frequently a problem. Carrying a container and separate serving means for food or drink for a pet when away from home can be cumbersome and take up a lot of space in a carrying means such as, for example, a backpack. It would therefore be highly desirable to provide a fully portable food and drink supply means with an integrated dispenser and server combined in one easy-to-use device.

### SUMMARY OF THE INVENTION

Embodiments of the present invention address the deficiencies of the prior art by providing a portable storage and carrying device for transporting food and drink for pets having an integrated releasable serving means.

The various embodiments of the present invention include a portable container body having an integrated, releasable base for serving food or drink to an animal when away from home. In such an embodiment, the base is removed from the container body and the contents of the container are poured into the base and the base set on the ground for consumption of the product by a pet.

In an alternate embodiment of the present invention, a container body has a releasable lid formed such that the contents of the container can be poured into the lid and the lid set on the ground for consumption of the product by a pet.

Thus, the invention is directed to a container comprising a body dimensioned and configured to hold a liquid or particulate solid, having an outer surface, and defining an opening therethrough. A bowl-like base is provided, having an inner surface and an outer surface. A portion of the outer surface of the body, and a corresponding portion of the inner surface of the base are dimensioned and configured to define a reversible, frictional engagement when the portion of the outer surface of the body and the corresponding portion of the inner surface of the base are nested.

To form the reversible engagement between the body and the base, the body defines at least one indentation, and the bowl-like base defines at least one corresponding protrusion, wherein the indentation and the protrusion engage matingly when the portion of the outer surface of the body and the corresponding portion of the inner surface of the base are nested.

The base may optionally further comprise a handle.

The container may optionally further comprise a lid dimensioned and configured to reversibly seal the opening passing through the body. The lid can be threaded or be a snap-cap-type closure.

In one version of the invention, the body defines at least one circumferential groove, and the bowl-like base defines at least one corresponding lip. In this version of the invention, the groove and the lip engage matingly when the portion of the outer surface of the body and the corresponding portion of the inner surface of the base are nested. Again, the base may optionally further comprise a handle. A lid may also be provided.

In another version of the invention, the portion of the outer surface of the body surrounds the opening through the body and defines threads, and the corresponding portion of the inner surface of the base defines threads that matingly engage with the threads in the body.

The various embodiments of the present invention can further include a label or molded identification means for identifying the product contained in the container body.

### BRIEF DESCRIPTION OF THE DRAWINGS

The teachings of the present invention can be readily understood by considering the following detailed description in conjunction with the accompanying drawings, in which:

FIG. 1A depicts a front elevation, partial cutaway diagram of a portable storage and carrying device for transporting food and drink for pets having an integrated releasable serving base in accordance with a first version of the invention.

FIG. 1B depicts an isolated front elevation diagram of the bottom portion of the body 102 of the invention, showing indents 106 for reversibly attaching the base 110 to the body 102.

FIG. 1C depicts an isolated front elevation diagram of the base 110.

FIG. 2A depicts a front elevation, partial cutaway diagram of a portable storage and carrying device for transporting food and drink for pets having an integrated releasable serving base in accordance with an alternate version of the invention.

FIG. 2B depicts an isolated front elevation diagram of the bottom portion of the body 202 of the invention, showing indents 206 for reversibly attaching the base 210 to the body 202.

FIG. 2C depicts an isolated front elevation diagram of the base 210.

FIG. 3A depicts a front elevation, partial cutaway diagram of a portable storage and carrying device for transporting food and drink for pets having an integrated releasable serving base in accordance with another alternate version of the invention. The magnified portion depicts the point where lip 307 of the lid 304 abuts shoulder 309 of the body 302.

FIG. 3B depicts a front elevation view of the version of the invention shown in FIG. 3A

FIG. 3C depicts an isolated front elevation diagram of the body 302.

FIG. 4A is a rendering of prior art, non-nesting water containers stacked three-deep within a storage rack or semi-tractor trailer.

FIG. 4B is a rendering of containers according to the present invention which nest, thereby saving enough space to allow them to be stacked four-deep.

FIG. 5A is a rendering of prior art, non-nesting water containers stacked two-deep within a storage rack or semi-tractor trailer.

FIG. 5B is a rendering of containers according to the present invention which nest, thereby saving space.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a container for transporting and storing food and drink for pets having an integrated releasable serving means. Although the present invention will be described primarily within the context of a specific size and shape portable serving bowl integrated to a similarly shaped container, the specific embodiments of the present invention should not be treated as limiting the scope of the invention. It will be appreciated by those skilled in the art and informed by the teachings of the present invention that within concepts of the present invention any size or shape portable serving device for pets can be integrated with a container for transporting food or drink using a variety of fastening means and methods.

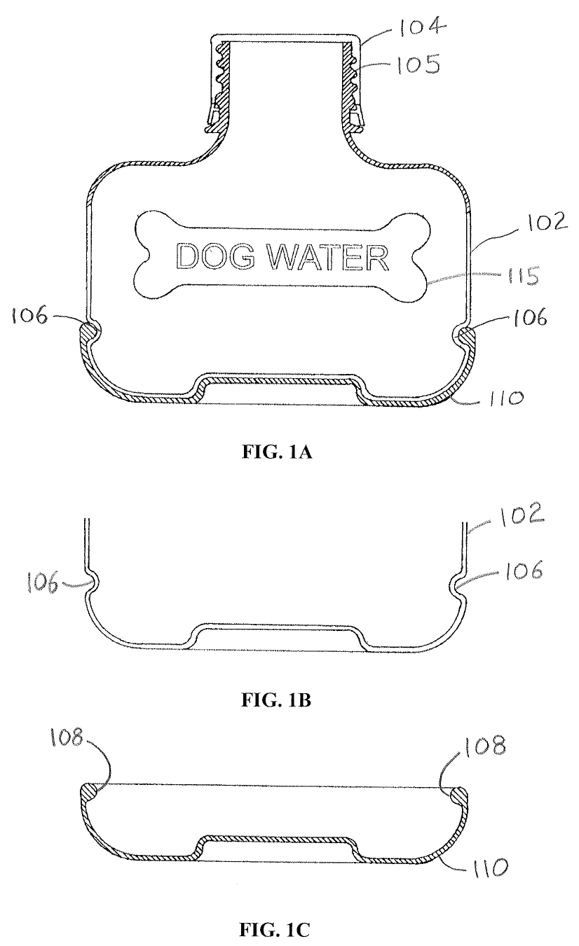

FIGS. 1A, 1B, and 1C depict front elevation diagrams of a portable storage and carrying device for transporting food and drink for pets having an integrated releasable serving base in accordance with an embodiment of the present invention. The version of the invention in FIGS. 1A, 1B, and 1C comprises a container body 102, a lid 104 and a releasable base 110. The bottom of the container body 102 is shown in isolation in FIG. 1B. The releasible base 110 is shown in isolation in FIG. 1C. In the embodiment of FIGS. 1A, 1B, and 1C, the releasable base 110 is attached to the container body 102 via one or more indents or a circumferential groove 106 in the container body 102. The indent or groove 106 is depicted in FIGS. 1A and 1B. A corresponding protrusion(s) or lip 108 on the base 110 (see FIG. 1C) engages the indent or groove 106 to reversibly attach the base 110 to the body 102. To remove the base 110 from the container body 102, a user simply pulls on the base 110 to detach the base 110 from the container body 102. An indent 106 may also be positioned within the body 102 so that the tip of a finger (or other tool) can be inserted behind lip 108 of the base 110 in order to grip and remove the base 110 from the container body 102. Thereafter, the lid 104 can be removed from the container body 102, and the product (e.g., dog treats, water, etc.) in the container body 102 can be poured into the base 110 and fed to a pet in the base 110. In FIG. 1A, the lid 104 is depicted as being secured to the container body 102 via mating threads 105. Other fasteners may also be utilized to secure the lid 105 to the body 102, such as a friction snap-cap, a locking, child-proof cap, and the like. Thus, in alternate embodiments of the invention, other fastening means and methods can be implemented for securing the lid 104 to the container body 102.

The base 110 can comprise a separately manufactured saucer which snaps onto the bottom of the container body 102. As depicted in FIGS. 1A and 1B, the container body 102 can have any number of indents 106 molded into its exterior wall, both to receive the base 110 and/or for purely decorative reasons. In various embodiments, the indents 106 may run around the entire circumference of the container body 102, thereby defining a circumferential groove.

The body 102, lid 104, and base 106 can be fabricated from any suitably stiff material such as glass and plastic. The body, lid and base preferably comprising a thermosetting or thermoplastic resin, most preferably a thermoplastic resin such as a polyolefin (e.g., polyethylene, polypropylene, and the like) or a polyester (e.g., polyethylene terephthalate). These plastics are durable, light in weight compared to glass, and are easily formed into a variety of shapes, and in a myriad of colors. The body, lid, and base need not all be fabricated from the same material. For example, the base 110 can be molded plastic or rubber, such that it separates from the body 102 with ease. The body 102, for example, could be fabricated from a more flexible plastic or an optically clear plastic, such as polyethylene terephthalate. The base 110 can have any number of lips or indents 108, acting as fasteners, which secure themselves in the bottles indentation ring via friction and the stiffness of the material from which the base 110 is made. As shown in FIG. 1C, the base 110 is shown with a continuous, circumferential lip 108 defined along its upper perimeter.

Indicia 115 may optionally be affixed, impressed, molded, adhered, or otherwise attached to the body 102.

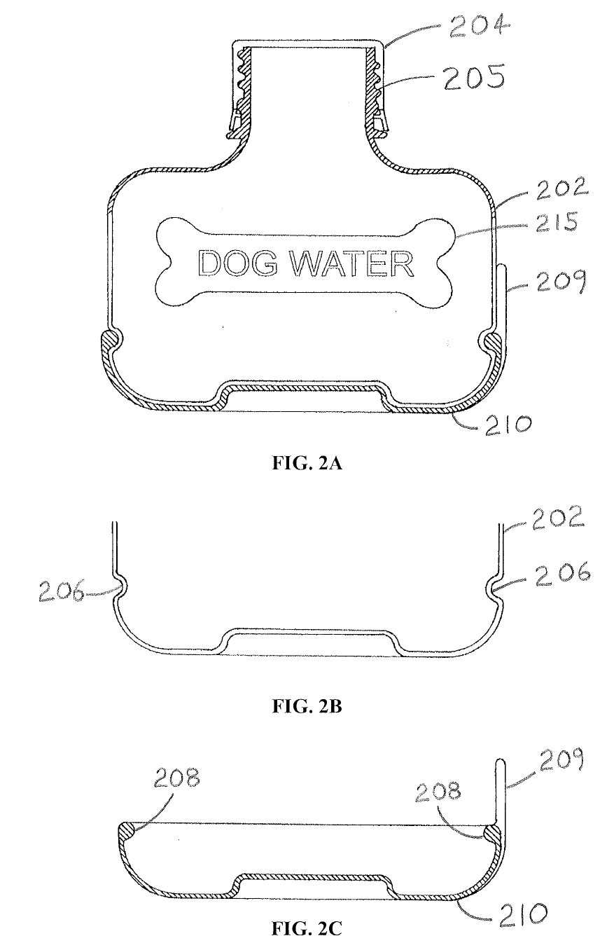

FIGS. 2A, 2B, and 2C depict front elevation diagrams of an alternate version of a portable storage and carrying device for transporting food and drink for pets having an integrated releasable serving base in accordance with the present invention. The embodiment of FIG. 2A comprises a container body 202, a lid 204 and a releasable base 210 as shown in FIG. 1A. However, in the version shown in FIGS. 2A and 2C, the releasable base 210 further includes a handle 209. The handle 209 serves to ease separating the base 210 from the body 202. In the same fashion as described for the first version of the invention, in the embodiment of FIGS. 2A, 2B, and 2C, the releasable base 210 is attached to the container body 202 via one or more indents or a circumferential groove 206 in the container body 202. See FIG. 2B. Corresponding indents or lip 208 in the base 210 form a frictional fit with indents 206 when the base is mated to the body 202. To remove the base 210 from the container body 202, a user can grab the handle 209 and use the handle 209 as a leverage point to pull the base 210 away from the container body 202. Thereafter, the lid 204 can be removed from the container body 202, and the product (e.g., dog treats, water, etc.) in the container body 202 can be poured into the base 210 and fed to a pet in the base 210. In addition, the handle 209 in the base 210 can be used to hold the base 210 while feeding a pet or to place the base 210 on a surface for feeding a pet. That is, the handle 209 is gripped and pulled downwards, starting the process of removing the base 110 from the container body 202. In FIG. 2A, the lid 204 is again depicted as being secured to the container body 202 via mating threads 205. As noted above, other fastening means and methods can be implemented for securing the lid 204 to the container body 202. Even further, in the embodiment of FIGS. 2A and 2C, the handle 209 of the base 210 can be shaped to have a shape similar to an animal's tongue (e.g., a dog tongue) solely for aesthetic purposes.

Indicia 215 may optionally be affixed, impressed, molded, adhered, or otherwise attached to the body 202, as shown in FIG. 2A.

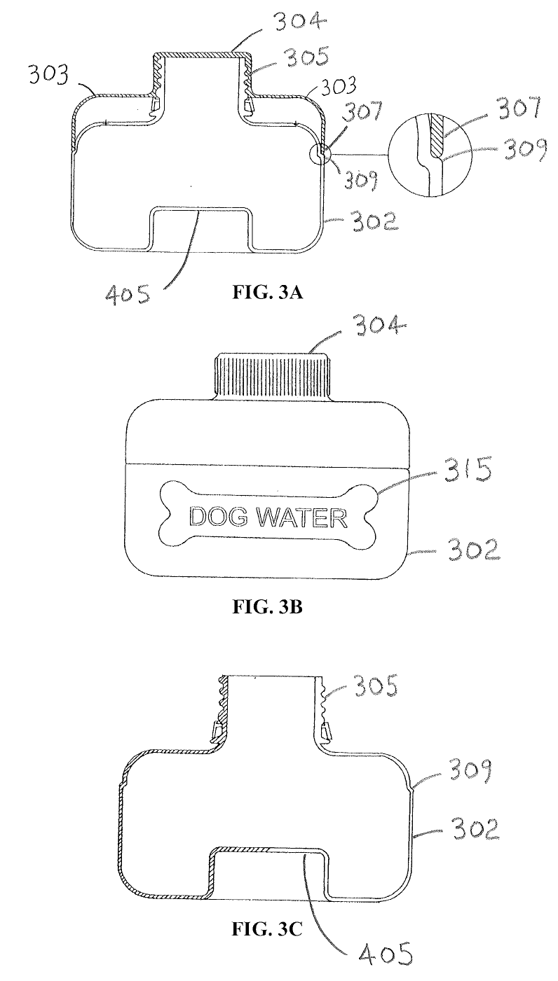

FIGS. 3A, 3B, and 3C depict front elevation diagrams of another version of a portable storage and carrying device for transporting food and drink for pets having an integrated releasable serving lid according to the present invention. The version shown in FIG. 3A, which is a partial cutaway view, comprises a container body 302 and a releasable lid 304. In the embodiment of FIG. 3A, the releasable lid 304 is illustratively attached to the container body 302 via mating threads 305. As shown in FIG. 3A, the lid 304 is widened to include shoulders 303 that terminate in a lip 307. In FIG. 3A, the container body 302 further includes an circumferential flange 309 upon which the lip 307 of the releasable lid 304 rests for support when the lid is attached to the container body 302. In the version shown in FIG. 3A, the lid 304 can be removed from the container body 302, and the product (e.g., dog treats, water, etc.) in the container body 302 can be poured into the lid 304 and fed to a pet in the lid 304. Although in the embodiment of FIG. 3A, the lid 304 is depicted as being secured to the container body 302 via threads 305, other fastening means and methods can be implemented for securing the lid 304 to the container body 302, as noted earlier. For example, an indent in the container body 302 and corresponding lip in the lid 304 can be used to secure the lid 304 to the container body 302 as described in FIG. 1A and FIG. 2A, above.

In addition, and as depicted in FIGS. 1A and 2A, as shown in FIGS. 3A and 3B, a descriptive label or other indicia 315 can be added to the container body for identifying the contents contained therein. The descriptive labels 115 (FIG. 1A), 215 (FIG. 2A), and 315 (FIG. 3B) can be shaped to mimic the shape of an animal's treat (e.g., a dog bone) for aesthetic purposes. As noted above, the indicia 315 may also be molded or stamped into the container body 102, 202, 302, the base 110, 210, 310, or the lid 104, 204, 304.

FIG. 3B depicts a front elevation view of the version of the invention shown in FIG. 3A without the cutaway. Shown are lid 304, body 302, and indicia 315. FIG. 3C depicts a front elevation view of the body 302 in isolation. Depicted are the threads 305 and the flange 309.

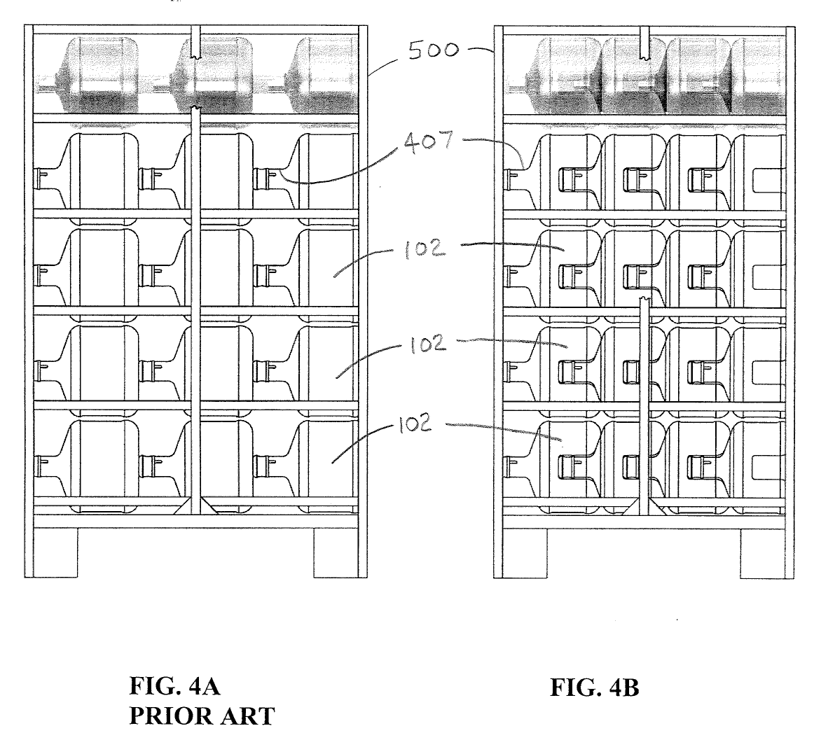

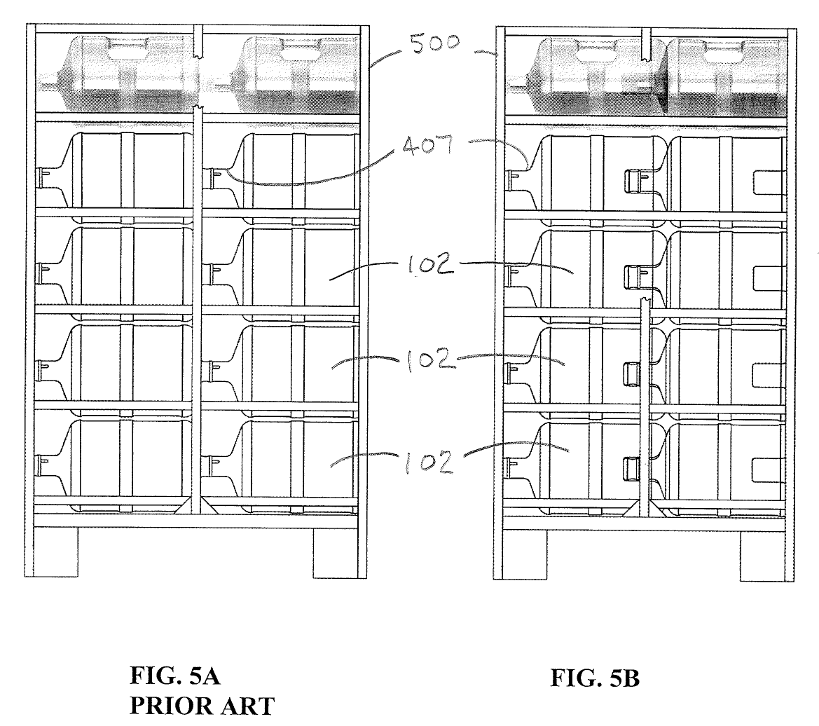

As depicted in FIGS. 3A and 3C, the body 102 includes a nesting indentation or punt 405. The nesting indentation 405 is dimensioned and configured to allow the neck of the body 102 to fit within it, thereby allowing a plurality of containers according to the present invention to be nested. This is advantageous when storing and shipping the containers, because when stacked vertically or horizontally, the nesting feature minimizes the amount of unutilized dead space within the shipping container or storage rack. This is depicted in FIGS. 4A, 4B, 5A, and 5B. FIGS. 4A and 5A depict prior art, non-nesting containers. Because the neck 407 of each prior art container does not nest within the adjacent container, there is a considerable amount of dead space within the shipping container or storage rack 500. In contrast, as shown in FIGS. 4B and 5B, in one version of the present invention, the neck 407 of each container nests within the nesting indentation or punt of the adjacent container. This feature of the invention allows for more volume of product to be shipped or stored within a confined space, such as a shipping container or warehouse rack. This feature also provides far more secure and stable stackability of free-standing containers when storing, shipping, and displaying the containers.

In addition the base 110, especially when manufactured out of rubber or other shock-absorbing material, acts as an absorber or dampener when moving, stacking, and unstacking the containers. This is advantageous for large volume liquid or solid containers which can be very heavy when full. This minimized cracking or damage to the container body 102.

The container of the present invention is not limited to storing or transporting liquid goods. It can also be used to storage and transport particulates, powders, gels, screws, bolts, craft objects such as buttons, and the like.

Having described various embodiments for a container for transporting and storing food and drink for pets having an integrated releasable serving means, (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

What is claimed is:

1. A container comprising:
a body dimensioned and configured to hold a liquid or particulate solid, having an outer surface, and defining an opening therethrough;
a bowl-like base having an inner surface and an outer surface;
wherein a portion of the outer surface of the body, and a corresponding portion of the inner surface of the base are dimensioned and configured to define a reversible, frictional engagement when the portion of the outer surface of the body and the corresponding portion of the inner surface of the base are nested.

2. The container of claim 1, wherein the body defines at least one indentation, and the bowl-like base defines at least one corresponding protrusion, wherein the indentation and the protrusion engage matingly when the portion of the outer surface of the body and the corresponding portion of the inner surface of the base are nested.

3. The container of claim 2, wherein the base further comprises a handle.

4. The container of claim 3, further comprising a lid dimensioned and configured to reversibly seal the opening passing through the body.

5. The container of claim 1, wherein the body defines at least one circumferential groove, and the bowl-like base defines at least one corresponding lip, wherein the groove and the lip engage matingly when the portion of the outer surface of the body and the corresponding portion of the inner surface of the base are nested.

6. The container of claim 5, wherein the base further comprises a handle.

7. The container of claim 6, further comprising a lid dimensioned and configured to reversibly seal the opening passing through the body.

8. The container of claim 1, wherein the body and the base are fabricated from materials comprising thermoplastic or thermosetting resins.

9. The container of claim 1, wherein the portion of the outer surface of the body surrounds the opening through the body and defines threads, and the corresponding portion of the inner surface of the base defines threads that matingly engage with the threads in the body.

10. The container of claim 9, wherein the base includes shoulder portions and a circumferential lip that engages a flange defined in the body.

11. The container of claim 9, wherein the body and the base are fabricated from materials comprising thermoplastic or thermosetting resins.

12. The container of claim 9, wherein the body and base define an indentation in a bottom surface of the body, wherein the indentation is dimensioned and configured to allow nesting of a plurality of the containers.

13. The container of claim 1, wherein the body and base define an indentation in a bottom surface of the body, wherein the indentation is dimensioned and configured to allow nesting of a plurality of the containers.
